(19) United States
(12) Patent Application Publication
(10) Pub. No.: US 2013/0057907 A1
(43) Pub. Date: Mar. 7, 2013

(54) NETWORK APPARATUS WITH FAX FUNCTION

(71) Applicant: Yun-Chung Lin, New Taipei City (TW)

(72) Inventor: Yun-Chung Lin, New Taipei City (TW)

(73) Assignees: Kinpo Electronics, Inc., New Taipei City (TW); Cal-Comp Electronics & Communications Company Limited, New Taipei City (TW)

(21) Appl. No.: 13/594,879

(22) Filed: Aug. 27, 2012

(30) Foreign Application Priority Data
Sep. 7, 2011 (TW) 100132256

(51) Int. Cl. H04N 1/40; H04M 11/00; G06K 15/02

(52) U.S. Cl. 358/1.15; 358/469; 358/444; 379/93.01

(57) ABSTRACT

A network apparatus with fax function is provided. The network apparatus includes a fax modem, a Wide Area Network (WAN) interface, a Local Area Network (LAN) interface, and a processing unit. The fax modem receives or transmits fax data. The WAN interface is connected to an external network, the external network uses an external Internet Protocol (IP) address, and the network apparatus is addressed by using a legal IP address on the external network. The LAN interface is connected to an internal LAN, and the internal LAN uses a private IP address. The processing unit works as an operation core of the network apparatus. An electronic device connected to the internal LAN shares the legal IP address of the network apparatus on the external network through the network apparatus. Thus, the network apparatus has a fax function, and the cost is further reduced.

### CROSS-REFERENCE TO RELATED APPLICATION

This application claims the priority benefit of Taiwan application serial no. 100132256, filed on Sep. 7, 2011. The entirety of the above-mentioned patent application is hereby incorporated by reference herein and made a part of this specification.

### BACKGROUND OF THE INVENTION

1. Field of the Invention

The present invention relates to a fax technology, in particular, to a network apparatus with fax function.

2. Description of Related Art

In recent years, networks have been spread in various working environments and families due to the rapid popularization of the networks. However, legal Internet Protocol (IP) addresses are limited resources, and when a plurality of network users connected to an internal network all has a requirement of using the public Internet, an IP address sharer (usually called an IP sharer) thus emerges, which enables several hosts to use the same public IP address, and perform address translation between a private IP address and an external IP address, thereby enabling the plurality network users to share resources through network connection.

In a conventional fax process, a user walks to a fax machine to put fax data into a cassette, inputs a fax number, and then starts the fax. Alternatively, a user transmits fax data and a fax number to a fax machine at a computer end through a fax driver, and then starts the fax. When the user needs to use the fax function, a machine with fax function should be additionally purchased, which increases the cost of development and production of products. Therefore, how to use the fax function on an existing IP sharer is an issue to be solved.

### SUMMARY OF THE INVENTION

Accordingly, the present invention is directed to a network apparatus with fax function, which effectively enables the use of fax function on an existing network apparatus.

The present invention provides a network apparatus with fax function, which includes: a fax modem, a Wide Area Network (WAN) interface, a Local Area Network (LAN) interface, and a processing unit. The fax modem receives or transmits fax data. The WAN interface is connected to an external network, the external network uses an external IP address, and the network apparatus is addressed by using a legal IP address on the external network. The LAN interface is connected to an internal LAN, and the internal LAN uses a private IP address. The processing unit works as an operation core on the network apparatus. An electronic device connected to the internal LAN shares the legal IP address of the network apparatus on the external network through the network apparatus.

In an embodiment of the present invention, the network apparatus further includes a Universal Serial Bus (USB) interface, a hard disk is connected to the USB interface or the internal LAN, and the network apparatus stores the fax data in the hard disk. In an embodiment of the present invention, a remote apparatus connected to the external network accesses the fax data stored in the hard disk through the network apparatus.

In an embodiment of the present invention, the network apparatus stores the fax data in a File Transfer Protocol (FTP) server connected to the internal LAN. In an embodiment of the present invention, a remote apparatus connected to the external network accesses the fax data stored in the FTP server through the network apparatus.

In an embodiment of the present invention, the processing unit executes software for a user to set a fax/phone number through a web page, and the network apparatus transmits the fax data according to the set fax/phone number.

In an embodiment of the present invention, the processing unit executes software for a user to set an email address through a web page, and the network apparatus sends the fax data in a form of email according to the set email address.

The present invention further provides a network apparatus with fax function, which includes: a network module, a fax module, and a work control module. The network module is coupled to an internal LAN and an external network, the external network uses an external IP address, the internal LAN uses a private IP address, and the network module performs address translation on the private IP address and the external IP address, so as to transmit data packets from the internal LAN to the external network and transmit data packets from the external network back to the internal LAN. The fax module coupled to a telephone line is used for receiving or transmitting fax data. The work control module controls a work flow of the network apparatus.

In an embodiment of the present invention, the network apparatus further includes a USB module, a hard disk is connected to the USB module or the internal LAN, and the network apparatus stores the fax data in the hard disk. In an embodiment of the present invention, a remote apparatus connected to the external network accesses the fax data stored in the hard disk through the network apparatus.

In an embodiment of the present invention, the network apparatus stores the fax data in an FTP server connected to the internal LAN. In an embodiment of the present invention, a remote apparatus connected to the external network accesses the fax data stored in the FTP server through the network apparatus.

In an embodiment of the present invention, the work control module executes software for a user to set a fax/phone number through a web page, and the network apparatus transmits the fax data according to the set fax/phone number.

In an embodiment of the present invention, the work control module executes software for a user to set an email address through a web page, and the network apparatus sends the fax data in a form of email according to the set email address.

The present invention further provides a network apparatus with fax function, the network apparatus is used for performing address translation on a private IP address and an external IP address, so as to transmit data packets from an internal LAN to an external network and transmit data packets from the external network back to the internal LAN. The network apparatus includes: a fax modem, a WAN interface, an LAN interface, and a processing unit. The fax modem receives or transmits fax data. The WAN interface is connected to the external network, and the external network uses the external IP address. The LAN interface is connected to the internal LAN, and the internal LAN uses the private IP address. The processing unit works as an operation core of the network apparatus.

In view of the above, in the present invention, a fax modem is added in the network apparatus, so that an electronic device connected to the internal LAN is enabled to share the legal IP address of the network apparatus on the external network through the network apparatus, the fax data can be stored in a hard disk or an FTP server, and the fax data can be transmitted according to the set fax/phone number or can be sent in a form of email according to the set email address. In this way, by storing the fax data and sending the fax data through the network apparatus, the user is enabled to use the fax function on the existing network, and moreover, the cost is further saved.

To make the above characteristics and advantages of the present invention apparent, the embodiments are illustrated in the following paragraphs in accompanying with the drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a network apparatus with fax function according to an embodiment of the present invention.

FIG. 2 is a system block diagram of a network apparatus with fax function according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

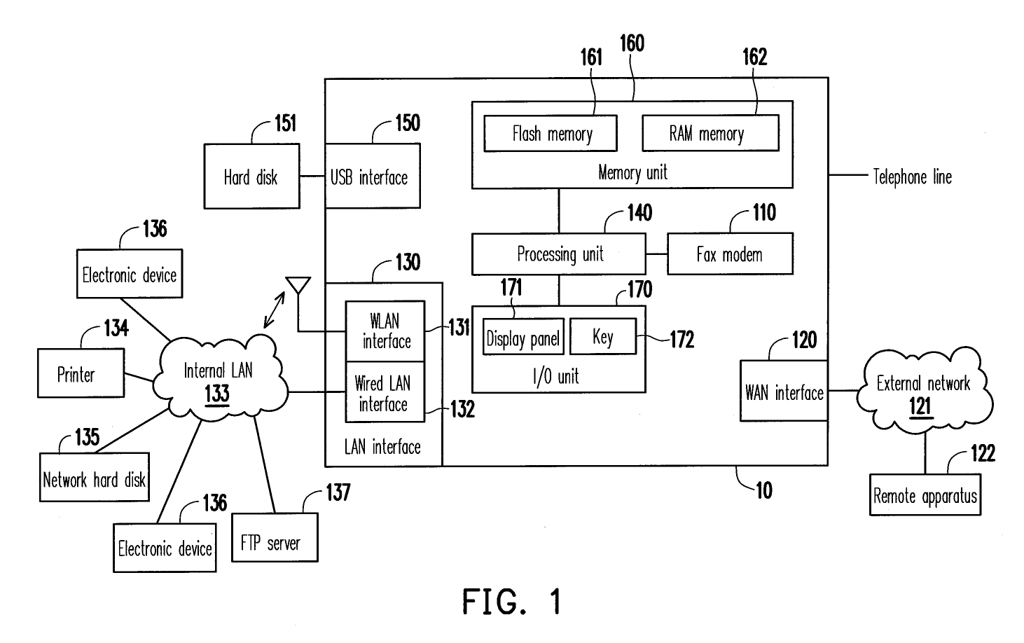

FIG. 1 is a block diagram of a network apparatus with fax function according to an embodiment of the present invention. Referring to FIG. 1, the network apparatus 10 with fax function may be an IP sharer or another network apparatus 10 with IP address sharing function. The network apparatus 10 includes a fax modem 110, a WAN interface 120, an LAN interface 130, a processing unit 140, a USB interface 150, a memory unit 160, and an Input/Output (I/O) unit 170. The processing unit 140 works as an operation core of the network apparatus 10, so as to control entire operation of the network apparatus 10. The memory unit 160 may be a non-volatile memory of any type, for example, a Flash memory 161 or a Random Access Memory (RAM) 162, but the present invention is not limited thereto. The I/O unit 170 has a display panel 171 and a key 172, the display panel 171 is used for displaying a status of the network apparatus 10, and the key 172 is used for setting functions of the network apparatus 10.

In this embodiment, the LAN interface 130 has a wireless LAN (WLAN) interface 131, for example, a WLAN interface based on IEEE 802.11 standard, and the LAN interface 130 may also has a wired LAN interface 132. The LAN interface 130 is connected to the internal LAN 133, and the internal LAN 133 uses a private IP addresses to address electronic devices 136 of the internal LAN 133. The electronic devices 136 include, for example, a desktop/laptop with network function, a Personal Digital Assistant (PDA), a smart phone, or other personal mobile devices. The WAN interface 120 is connected to an external network 121, the external network 121 uses an external IP address to address a remote apparatus 122 of the external network 121, and the network apparatus 10 is addressed by using a legal IP address on the external network 121. Any electronic device 136 connected to the internal LAN 133 shares, through the network apparatus 10 also connected to the internal LAN 133, the legal IP address of the network apparatus 10 on the external network 121, and accesses data of various equipment connected to the network apparatus 10.

The fax data received or transmitted by the fax modem 110 through a telephone line may be temporarily stored in the memory unit 160. The fax data received or transmitted at the network apparatus 10 may be stored in a hard disk 151 connected through a USB interface 150 or a network hard disk 135 connected through the internal LAN 133 (which depends on the requirement of the user and is not limited thereto). In addition, the remote apparatus 122 connected to external network 121 may access, through the network apparatus 10, the fax data stored in the hard disk 151 connected through the USB interface 150 or the network hard disk 135 connected through the internal LAN 133. The electronic device 136 connected to the internal LAN 133 mal also access, through the network apparatus 10, the fax data stored in the hard disk 151 connected through the USB interface 150, or the electronic device 136 may access the fax data in the network hard disk 135 directly through the internal LAN 133.

On the other hand, the network apparatus 10 may store the received or transmitted fax data in an FTP server 137 connected to the internal LAN 133 through the internal LAN 133. The remote apparatus 122 connected to external network 121 may also access the fax data stored in the FTP server 137 through the network apparatus 10, and the electronic device 136 connected to the internal LAN 133 may further access the fax data stored in the FTP server directly through the internal LAN 133.

Before the user needs to transmit the fax data, the processing unit 140 executes a software program, for the user to set related information of a fax/phone number, such as a user name and a fax/phone number, through a web page by using the remote apparatus 122 connected to the external network 121 or the electronic device 136 connected to the internal LAN 133, and the network apparatus 10 transmits the fax data according to the set fax/phone number. In addition, the processing unit 140 may also execute a software program for the user to set related information of an email address, such as a user name and an email address, through a web page, and the network apparatus 10 sends the fax data in a form of email according to the set email address, in which the fax data may be data received by the fax modem 110 through the telephone line.

When the user needs to print the fax data, the network apparatus 10 may transmit the fax data to a printer 134 connected to the USB interface 150 or connected to the internal LAN 133 for printing.

In addition, the remote apparatus 122 connected to the external network 121 or the electronic device 136 connected to the internal LAN 133 may access a fax status of the network apparatus 10, such as whether have fax data received and total number of fax data papers, and execute a fax setting of the network apparatus 10, for example, designating the fax data to be stored in the hard disk 151, the network hard disk 135, or the FTP server 137 after receiving the fax data, printing the fax data, or sending the fax data in a form of email according to the set email address.

Accordingly, the network apparatus 10 of this embodiment enables the electronic device 136 connected to the internal LAN 133 to share the legal IP address of the network apparatus 10 on the external network 121 through the network apparatus 10, stores the fax data in the hard disk 151 or the FTP server 137, transmits the fax data according to the set fax/phone number or sends the fax data in a form of email according to the set email address, and further prints the fax data according to requirements of the user. Moreover, the remote apparatus 122 connected to external network 121 or the electronic device 136 connected to the internal LAN 133 may access the fax status of the network apparatus 10 and execute the fax setting of the network apparatus 10. In this way, the user may store and send the fax data through the network apparatus 10, which not only enables the user to use the fax function on the existing network, but also further reduces the cost.

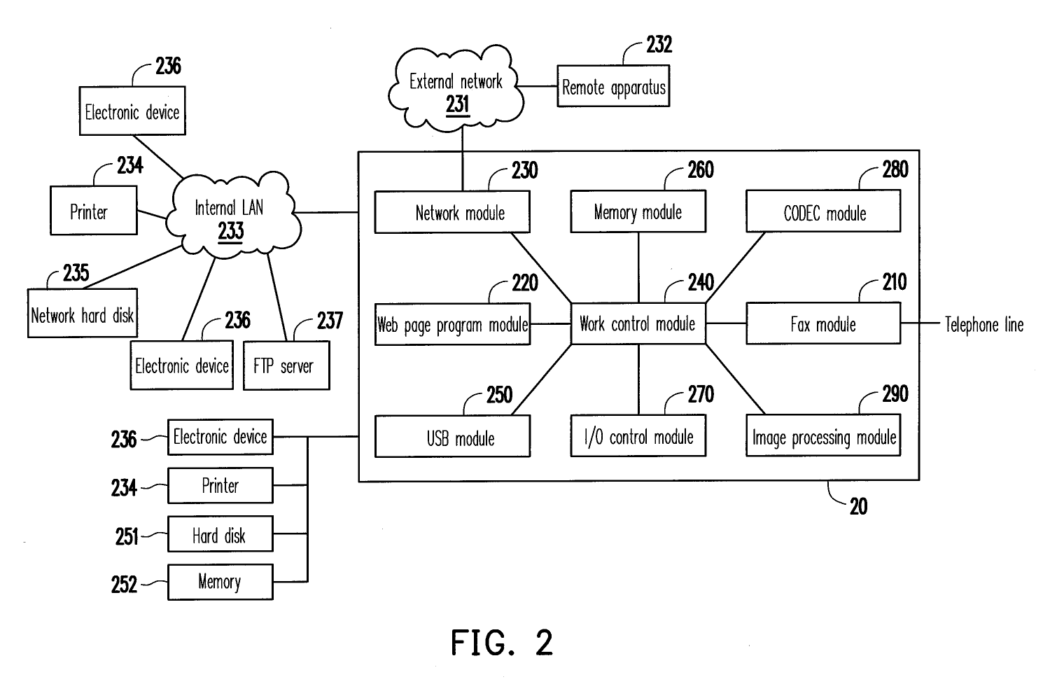

Based on the disclosure/teaching of the above embodiment, FIG. 2 shows a system block diagram of a network apparatus with fax function according to an embodiment of the present invention. Referring to FIG. 2, the network apparatus 20 with fax function includes a fax module 210, a web page program module 220, a network module 230, a work control module 240, a USB module 250, a memory module 260, an I/O control module 270, a coder-decoder (CODEC) module 280, and an image processing module 290.

The network module 230 includes various network communications possessed by the IP sharer, such as Hypertext Transfer Protocol (HTTP), FTP, and Simple Mail Transfer Protocol (SMTP). The network module 230 is coupled to the internal LAN 233 and the external network 231, the external network 231 uses an external IP address, the internal LAN 233 uses a private IP address, and the network module 230 performs address translation on the private IP address and the external IP address, so as to transmit data packets from the internal LAN 233 to the external network 231 and transmit data packets from the external network 231 back to the internal LAN 233, thereby transmitting and receiving network data. The fax module 210 coupled to a telephone line is capable of receiving or transmitting the fax data, and performing suitable translation on the fax data according to a fax protocol. The work control module 240 controls a work flow of the network apparatus 20, for example, transmitting the fax data to a designated device, such as a printer 234, a network hard disk 235, an electronic device 236, and an FTP server 237, and setting the communication of the network apparatus 20, such as, setting the telephone line: adjusting the tune or pulse, connecting the telephone line connected to a Public Switched Telephone Network (PSTN) or a Private Branch Exchange (PBX).

The fax data received or transmitted at the network apparatus 20 may be stored in the hard disk 251 connected to the USB module 250, a memory 252, or the network hard disk 235 connected to the internal LAN 233, and USB data received or transmitted at the USB module 250 is appropriately translated according to different purposes. A remote apparatus 232 connected to the external network 231 may access the fax data stored in the hard disk 251 connected to the USB module 250 or the network hard disk 235 connected to the internal LAN 233 through the network apparatus 20. An electronic device 236 connected to the internal LAN 233 may also access the fax data stored in the hard disk 251 connected to the USB interface 250 through the network apparatus 20 or access the fax data in the network hard disk 235 directly through the internal LAN 233.

In this embodiment, the web page program module 220 is responsible for setting the network apparatus 20, for example, a telephone book and processing on designated faxes. The memory module 260 registers the data of the network apparatus 20. The I/O control module 270 controls a panel, a Light Emitting Diode (LED), and a key of the I/O unit. The CODEC module 280 compresses and decompresses the fax data. The image processing module 290 performs format conversion of the fax data.

On the other hand, the network apparatus 20 may store the fax data received or transmitted by the internal LAN 233 in an FTP server 237 connected to the internal LAN 233 through the internal LAN 233. The remote apparatus 232 connected to the external network 231 may access the fax data stored in the FTP server 237 through the network apparatus 20, and the electronic device 236 connected to the internal LAN 233 may further access the fax data stored in the FTP server 237 directly through the internal LAN 233.

When the user needs to transmit the fax data, the work control module 240 executes a web page program, for the user to set related information of a fax/phone number, such as a user name and a fax/phone number, through a web page by using the remote apparatus 232 connected to the external network 231 or the electronic device 236 connected to the internal LAN 233, and the network apparatus 20 transmits the fax data according to the set fax/phone number. In addition, when the user needs to send the fax data, the work control module 240 also executes a web page program, for the user to set related information of an email address, such as a user name and an email address, through a web page, and the network apparatus 20 then sends the fax data in a form of email according to the set email address.

When the user needs to print the fax data, the network apparatus 20 may send the fax data to a printer 234 connected to the USB module 250 or the internal LAN 233 for printing.

In addition, the remote apparatus 232 connected to the external network 231 or the electronic device 236 connected to the internal LAN 233 may access a fax status of the network apparatus 20, for example, the network apparatus 20 is in a standby status, a transmitting status, or a receiving status, the number of pages of actually transmitted fax data, the number of pages of actually received fax data, and other related status, and executes a fax setting of the network apparatus 20, for example, setting for transmitting the fax data, including: color degree, quality and heads of the fax data, and setting for receiving the fax data, including: designating the fax data to be stored in the hard disk 251 or the FTP server 237 when receiving the fax data, printing the fax data, or converting the fax data into an email.

From another viewpoint, an embodiment of a network apparatus with fax function may be of another form, for example, the network apparatus may perform address translation on an private IP address and an external IP address, so as to transmit data packets from an internal LAN to an external network and transmit data packets from the external network back to the internal LAN. The network apparatus includes: a fax modem, a WAN interface, an LAN interface, and a processing unit. The fax modem receives or transmits fax data; the WAN interface is connected to the external network, and the external network uses the external IP address; the LAN interface is connected to the internal LAN, and the internal LAN uses the private IP address; and the processing unit works as an operation core of the network apparatus.

However, the above embodiments are only illustrated for describing the concept of the present invention, instead of limiting actual application manner of the present invention.

In view of the above, in the present invention, a fax modem is added in the network apparatus, so that the electronic device connected to the internal LAN may share the legal IP address of the network apparatus on the external network through the network apparatus, the fax data may be stored in the hard disk or the FTP server, the fax data may be transmitted according to the set fax/phone number or sent in a form of email according to the set email address, and the fax data may further be printed as required by the user. Moreover, the remote apparatus connected to the external network or the electronic device connected to the internal LAN may access the fax status of the network apparatus and execute the fax setting of the network apparatus. In this way, the user may store and send the fax data through the network apparatus on the internal LAN, the fax function of the IP sharer enables a general office to dispose only one IP sharer for all users to use the fax function, thereby saving the cost for purchasing the fax machine. The IP sharer may be used in a wired manner and a wireless manner, which facilitates a smart phone or a tablet only having a wireless device to use the fax function and detect the fax data at a remote end.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A network apparatus with fax function, comprising:
a fax modem, for receiving or transmitting fax data;
a Wide Area Network (WAN) interface, connected to an external network, wherein the external network uses an external Internet Protocol (IP) address, and the network apparatus is addressed by using a legal IP address on the external network;
a Local Area Network (LAN) interface, connected to an internal LAN, wherein the internal LAN uses a private IP address; and
a processing unit, for working as an operation core of the network apparatus,
wherein at least one electronic device connected to the internal LAN shares the legal IP address of the network apparatus on the external network through the network apparatus.

2. The network apparatus with fax function according to claim 1, further comprising a Universal Serial Bus (USB) interface, wherein a hard disk is connected to the USB interface or the internal LAN, and the network apparatus stores the fax data in the hard disk.

3. The network apparatus with fax function according to claim 2, wherein a remote apparatus connected to the external network accesses the fax data stored in the hard disk through the network apparatus.

4. The network apparatus with fax function according to claim 1, wherein the fax data is stored in a File Transfer Protocol (FTP) server connected to the internal LAN.

5. The network apparatus with fax function according to claim 4, wherein a remote apparatus connected to the external network accesses the fax data stored in the FTP server through the network apparatus.

6. The network apparatus with fax function according to claim 1, wherein a remote apparatus connected to the external network accesses a fax status of the network apparatus and executes a fax setting of the network apparatus.

7. The network apparatus with fax function according to claim 1, further comprising a USB interface, wherein a printer is connected to the USB interface or the internal LAN, and the network apparatus transmits the fax data to the printer for printing.

8. The network apparatus with fax function according to claim 1, wherein the processing unit executes software for a user to set a fax/phone number through a web page, and the network apparatus transmits the fax data according to the set fax/phone number.

9. The network apparatus with fax function according to claim 1, wherein the processing unit executes software for a user to set an email address through a web page, and the network apparatus sends the fax data in a form of email according to the set email address.

10. The network apparatus with fax function according to claim 1, wherein the network apparatus is an IP sharer.

11. The network apparatus with fax function according to claim 10, further comprising a memory unit, comprising a Flash memory and a Random Access Memory (RAM), for temporarily storing the fax data.

12. The network apparatus with fax function according to claim 10, further comprising an Input/Output (I/O) unit, comprising a key and a display panel, for setting the network apparatus and displaying a status of the network apparatus.

13. A network apparatus with fax function, comprising:
a network module, coupled to an internal Local Area Network (LAN) and an external network, wherein the external network uses an external Internet Protocol (IP) address, the internal LAN uses a private IP address, and the network module performs address translation on the private IP address and the external IP address, so as to transmit data packets from the internal LAN to the external network and transmit data packets from the external network back to the internal LAN;
a fax module, coupled to a telephone line, for receiving or transmitting fax data; and
a work control module, for controlling a work flow of the network apparatus.

14. The network apparatus with fax function according to claim 13, further comprising a Universal Serial Bus (USB) module, wherein a hard disk is connected to the USB module or the internal LAN, and the network apparatus stores the fax data in the hard disk.

15. The network apparatus with fax function according to claim 14, wherein a remote apparatus connected to the external network accesses the fax data stored in the hard disk through the network apparatus.

16. The network apparatus with fax function according to claim 13, wherein the fax data is stored in a File Transfer Protocol (FTP) server connected to the internal LAN.

17. The network apparatus with fax function according to claim 16, wherein a remote apparatus connected to the external network accesses the fax data stored in the FTP server through the network apparatus.

18. The network apparatus with fax function according to claim 13, wherein a remote apparatus connected to the external network accesses a fax status of the network apparatus and executes a fax setting of the network apparatus.

19. The network apparatus with fax function according to claim 13, further comprising a USB module, wherein a printer is connected to the USB module or the internal LAN, and the network apparatus transmits the fax data to the printer for printing.

20. The network apparatus with fax function according to claim 13, wherein the work control module executes software for a user to set a fax/phone number through a web page, and the network apparatus transmits the fax data according to the set fax/phone number.

21. The network apparatus with fax function according to claim 13, wherein the work control module executes software for a user to set an email address through a web page, and the network apparatus sends the fax data in a form of email according to the set email address.

22. A network apparatus with fax function, for performing address translation on a private Internet Protocol (IP) address and an external IP address, so as to transmit data packets from an internal Local Area Network (LAN) to an external network and transmit data packets from the external network back to the internal LAN, the network apparatus comprising:
a fax modem, for receiving or transmitting fax data;
a Wide Area Network (WAN) interface, connected to the external network, wherein the external network uses the external IP address;
an LAN interface, connected to the internal LAN, wherein the internal LAN uses the private IP address; and
a processing unit, for working as an operation core of the network apparatus.
